(19) United States
(12) Patent Application Publication
(10) Pub. No.: US 2005/0039959 A1
(43) Pub. Date: Feb. 24, 2005

(54) Vehicle with an air-conditioning system and a heat source

(76) Inventors: Frank Fruhauf, Aichwald (DE); Klaus Harm, Stuttgart (DE); Alfons Rennefeld, Stuttgart (DE); Jurgen Wertenbach, Fellbach (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 10/893,788

(22) Filed: Jul. 16, 2004

Related U.S. Application Data
(63) Continuation-in-part of application No. PCT/EP02/14058, filed on Dec. 11, 2002.

(30) Foreign Application Priority Data
Jan. 18, 2002 (DE) 102 01 741.7

(51) Int. Cl. B60L 11/18

(52) U.S. Cl. 180/65.3

(57) ABSTRACT

In a vehicle having an air-conditioning system and a heat source, wherein a common medium for cooling and heating is used in the air-conditioning system and the heat source, and which includes means for expanding and compressing the medium in a medium circuit, the medium circuit includes a first branch which extends between a combining point and a branching point, where the medium circuit branches off into a first sub-circuit extending through the heat source, and a second sub-circuit extending through the air-conditioning system, and the sub-circuits are combined again at the combining point, and a compressor and a first heat exchanger cooled by ambient air are arranged in the first branch between the combining point and the branch point.

This is a Continuation-in-Part application of international application PCT/EP02/14058 filed Dec. 11, 2002 and claiming the priority of German application 102 01 741.7 filed Jan. 18, 2002.

### BACKGROUND OF THE INVENTION

The invention relates to a vehicle with an air-conditioning system and a heat source, and to a method for heating and cooling the vehicle.

In modern fuel cell operated vehicles, all of the waste heat in the vehicle is dissipated to the ambient air via a central cooling module. At high ambient temperatures and under critical driving conditions, such as when driving uphill or pulling a trailer, the driving power may be limited as a result. If the ambient temperature is very high, there is an insufficient temperature drop to dissipate sufficient amounts of heat. The dissipation of heat is additionally adversely affected by the high flow resistance, since the heat exchangers are connected in series with respect to the cooling air flow in the cooling module. On the other hand, if the outside temperatures are low, there is a heat deficit in fuel cell vehicles which manifests itself in particular during a cold start or during part-load operation. It has already been proposed to use additional heating means, such as hydrogen or methanol burners, in order to compensate for this heat deficit.

German patent application DE 101 52 233 discloses a fuel cell system in which a heat pump is used in order to bring the waste heat from the fuel cell unit to a higher temperature level. In this case, it is also possible to effectively dissipate heat from the system at relatively high outside temperatures.

DE 43 04 076 C2 discloses an electric vehicle with an air-conditioning system, in which the vehicle interior compartment is dehumidified by conducting the humid supply air through an adsorber for drying the air.

Furthermore DE 196 44 583 A1 discloses a vehicle with a refrigerant circuit, in which an evaporator, a compressor, a condenser and a heat exchanger cooled by ambient air are arranged in succession in a sub-circuit assigned to the air-conditioning system. Furthermore, in a second sub-circuit an additional heat source is arranged in parallel with the evaporator.

Finally, DE 198 06 654 A1 discloses a vehicle with a refrigerant circuit, in which a compressor, a heat exchanger cooled by ambient air, a first part of an internal heat exchanger, a heat exchanger assigned to the vehicle interior compartment and the second part of the internal heat exchanger are arranged in succession in the direction of flow of the refrigerant. Two switching devices are provided upstream and downstream of the heat exchanger assigned to the vehicle interior compartment, in order to connect the compressor, the heat exchanger assigned to the vehicle interior compartment and a heat exchanger assigned to a heat source in a second switching position in series in the direction of the refrigerant flow.

It is the object of the present invention to provide a vehicle having an air-conditioning system and a heat source, in which, at high outside air temperatures, both comfortable air conditioning and sufficient cooling of the heat sources are made possible and, at low outside temperatures, a heat deficit can easily be compensated for. Also a method for heating and cooling the vehicle should be provided.

### SUMMARY OF THE INVENTION

In a vehicle having an air-conditioning system and a heat source, wherein a common medium for cooling and heating is used in the air-conditioning system and the heat source, and which includes means for expanding and compressing the medium in a medium circuit, the medium circuit includes a first branch which extends between a combining point and a branching point, where the medium circuit branches off into a first sub-circuit extending through the heat source, and a second sub-circuit extending through the air-conditioning system, and the sub-circuits are combined again at the combining point, and a compressor and a first heat exchanger cooled by ambient air are arranged in the first branch between the combining point and the branch point.

The advantage of the solution according to the invention is that both, cooling of the heat source and air conditioning of the vehicle, are made possible using the same medium. With a single refrigeration circuit, it is possible to perform a plurality of cooling and/or heating functions simultaneously depending on the demand of the individual heat sources and/or heat sinks or consumers in the system. Furthermore, the number of cooling circuits required in the vehicle is reduced. Heating can be carried out on demand and by selection. Furthermore, it is possible in a simple way to increase the number of heat consumers in the system as desired. The operating efficiency in particular of a fuel cell vehicle at high outside temperatures is improved.

The invention is particularly advantageous for use in a vehicle having a fuel cell system. If the outside temperatures are low, it is possible to increase the operating range of the vehicle compared to an electrically heated vehicle by utilizing ambient heat in heat pump mode.

The invention will become more readily apparent from the following description of a preferred embodiment thereof described below in more detail on the basis of the accompanying drawings.

### BRIEF DESCRIPTION OF THE DRAWINGS

FIG. 1 shows a basic circuit of a preferred refrigeration circuit for high outside temperatures,

FIG. 2 shows a basic circuit of a preferred extended refrigeration circuit for high outside temperatures,

FIG. 3 shows a basic circuit of a preferred refrigeration circuit for low outside temperatures, and

FIG. 4 shows a basic circuit for a preferred extended range refrigeration circuit for low outside temperatures.

### DESCRIPTION OF PREFERRED EMBODIMENTS

A vehicle in accordance with the invention has an air-conditioning system and a heat source which is to be cooled. A heat source of this type may, for example, be a charge air cooler of a vehicle driven by an internal combustion engine, in which the heated, compressed air needs to be cooled.

In a particularly preferred arrangement, the vehicle has a fuel cell system as heat source. The invention is described below on the basis of a vehicle of this type, in which the heat source is at least one component of the fuel cell system which is to be cooled. The fuel cell system may be used to supply power to the vehicle drive or to supply power to additional equipment in the vehicle. The fuel cell system comprises a fuel cell unit having an anode-side feed line for operating medium supplied to the fuel cell unit and an anode-side anode exhaust-gas line for discharging the anode exhaust gas from the fuel cell unit, a cathodeside feed line for feeding oxidizing agent to the fuel cell unit, and a cathode-side cathode exhaust-gas line for discharging the cathode exhaust gas from the fuel cell unit.

The fuel cell system may also include a gas generation system, in which an operating medium, preferably hydrogen, is generated from a fuel as it is well-known to the person skilled in the field of fuel cell technology.

According to the invention, the air-conditioning system and at least one component of the fuel cell system use a common medium for cooling and/or heating purposes by means of a medium circuit. It is particularly preferable for the medium in the medium circuit to be gaseous under standard conditions. The medium used is preferably carbon dioxide. The term standard conditions is to be understood to mean ambient air conditions of atmospheric pressure and approximately 20° C. A gaseous medium has the major advantage that both, the pressure and temperature of the gas, can easily be varied within wide ranges by compression and expansion of the gas. The state of aggregation of the medium may also change, for example from the gaseous state to the liquid state. The considerable temperature range allows components to be cooled and heated using the same medium. Carbon dioxide is a particularly suitable medium for vehicles, since it is nontoxic and noncombustible and therefore offers a high level of safety.

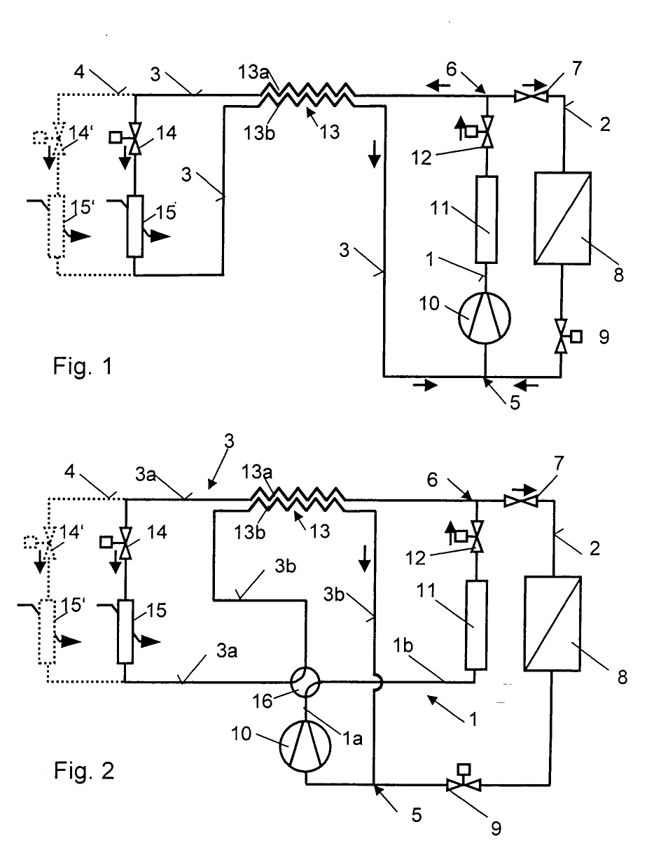

FIG. 1 illustrates a preferred basic medium circuit. Details of the fuel cell system are not shown. The basic circuit shown is particularly suitable for summer operation when, at high outside air temperatures, the vehicle needs to be cooled.

A first branch 1 of the medium circuit extends between a combining point 5 and a branching point 6. At the branching point 6 the medium circuit branches off into a first sub-circuit 2 and a second sub-circuit 3, and these sub-circuits are combined again at the combining point 5. The first sub-circuit 2 is assigned to the fuel cell system, and the second sub-circuit 3 is assigned to the air-conditioning system of the vehicle. In one preferred configuration, a condenser is arranged in the cathode exhaust-gas line as a component 8 for cooling cathode exhaust air from the fuel cell unit. This condenser 8 is cooled by the medium flowing through the first sub-circuit 2. Process water is condensed out of the fuel cell exhaust gas. Since the product water formed during the reaction in the fuel cell unit is mostly produced in the cathode exhaust air, cooling of the cathode exhaust air is particularly expedient with a view to recovering the process water. This can be returned to the fuel cell system for process gas humidification or for carrying out chemical reactions in a known way for known purposes. However, a corresponding component may also be arranged in the anode exhaust-gas line. According to the invention, the condensation capacity of the condenser can be controlled more accurately and more spontaneously in comparison with a conventional cooling circuit of the fuel cell system.

However, it is also possible for the medium of the first sub-circuit 2 to flow through a heat-exchange component of a gas generation system, assigned to the fuel cell system, for generating an operating medium for the fuel cell unit, so that the heat-exchange component is cooled in this way; this component is preferably a stage for the selective oxidation of carbon monoxide impurities or other components in which waste heat is produced and has to be dissipated. It is also possible, for example, for the medium of the first sub-circuit 2 to flow through parts of the fuel cell unit.

A compressor 10, a first heat exchanger 11 and a third valve 12 are arranged in the first branch 1 between the combining point 5 and the branching point 6 one after the other in the direction of flow of the medium. The first heat exchanger 11 is preferably an air cooler, which has ambient air flowing through it so as to exchange thermal energy with the medium. The compressor 10 compresses the medium to a high pressure, during which process the medium is heated accordingly. The medium is cooled in the first heat exchanger 11 and the heat is dissipated to the environment. The medium then passes through the third valve 12, which is preferably an open expansion valve. The mass flow of medium may be distributed between the sub-circuits 2, 3 as a function of the demand for refrigeration in the sub-circuits.

A first valve 7 is arranged in the first sub-circuit 2 upstream of the fuel cell component 8 of the fuel cell system in the direction of flow of the medium. This valve expands the medium to a predetermined first pressure pl. As a result, the medium is cooled to a first temperature T1. A second valve 9, which expands the medium to a second pressure p2, is arranged downstream of the fuel cell component 8. This second pressure corresponds to the pressure of the medium in the second sub-circuit 3 in the region of the combining point 5. The medium, which has been expanded to an intermediate pressure level by the first valve 7, takes up heat in the component 8 before being expanded to the lower pressure p2 by the second valve 9. The humid process air is cooled and dehumidified in the component 8. Valve 7 may be controllable or may be a simple valve with a fixed setting. Valve 9 is preferably a controllable valve. If, in addition to valve 9, valve 7 is also controllable, it is possible to provide better control of the refrigeration capacity at the component 8 and to control the installation either to the operating point of maximum efficiency or the operating point of maximum refrigeration or heating capacity. This also applies to additional heat suppliers corresponding to the component 8. The refrigeration capacity at an individual heat consumer can be set in targeted fashion by means of controllable valves upstream and downstream of a heat consumer.

A second heat exchanger 13, a fourth valve 14 and a third heat exchanger 15 are arranged, one behind the other in the direction of flow of the medium, in the second sub-circuit 3, the medium flowing through a first region 13a of the second heat exchanger 13. After it has passed through the third heat exchanger 15, the medium in the sub-circuit 3 then flows between the fourth valve 14 and the combining point 5 through a second region 13b of the second heat exchanger 13. This second heat exchanger 13 serves as an internal heat exchanger and reheats the medium on its way to the compressor 10, while at the same time cooling the medium which enters the second sub-circuit 3. When it passes through the fourth valve 14, which is preferably an expansion valve, the medium which has been cooled in the internal heat exchanger 13, is cooled further by expansion before passing through the third heat exchanger 15. A preferred temperature level is between 10° C. and 0° C. The third heat exchanger 15 is preferably assigned to the interior compartment of the vehicle. In this third heat exchanger 15, the medium takes up heat from the air for the interior vehicle compartment and cools and dries this air before passing through the second heat exchanger 13 for the second time in the second region 13b, where it is superheated and ultimately returned to the compressor 10.

Optionally additional heat sources may be connected in parallel with the third heat exchanger 15 and cooled. Power electronics in the vehicle may constitute one further heat source of this nature.

It is expedient for the medium to be made available on demand with a corresponding refrigeration capacity at each additional heat exchanger by means of an upstream expansion valve. The upstream valve can be used to set the mass flow of the medium through the valve and therefore the refrigeration capacity, and if appropriate a desired pressure level can be set using a second, downstream valve.

It is advantageous that the overall refrigeration energy available in the medium circuit and the temperature level of the refrigeration can be distributed to individual heat sources according to the particular demand by changing the valve positions of the fourth valve 14 and further valves 14′ arranged in further sub-circuits 4 and the second valve 9 with respect to one another. The valves 9, 12, 14, 14′ are preferably controllable and valve 7 may also be controllable.

A further preferred configuration is illustrated in FIG. 2. Components identical to those shown in FIG. 1 are denoted by the same reference numerals.

In the outline sketch presented, a flow-diverter valve 16 is arranged downstream of the compressor 10, as seen in the direction of flow of the medium. The flow-diverter valve 16 connects the first branch 1 to the second sub-circuit 3. The flow-diverter valve 16 divides the first branch 1 into two sections 1a, 1b and divides the second sub-circuit 3 into a first subsection 3a and a second subsection 3b. The first section la of the first branch 1 is the region between the combining point 5 and the flow-diverter valve 16, and the second section 1b is the region between flow-diverter valve 16 and branching point 6. The section 3a of the second sub-circuit 3 is the region between the flow-diverter valve 16 and the branching point 6, and the section 3b is the region between the flow-diverter valve 16 and the combining point 5.

With the flow-diverter valve 16, it is possible to choose between operating modes, and the medium which has been compressed in the compressor 10 can be passed into various parts of the medium circuit. As a result, by way of example, it becomes possible for various components of the vehicle or also of the fuel cell system to be heated.

The direction of flow of the medium in the individual parts of the medium circuit corresponds to that shown in FIG. 1, since the flow-diverter valve 16 in the first branch 1 interconnects the first and second sections 1a, 1b and in the second sub-circuit 3 interconnects the first and second sections 3a, 3b. This switching position is preferred if there is an excess of waste heat at relatively low outside temperatures and with the fuel cell system already having been heated up to its operating temperature.

If the ambient temperature is relatively low, down at approximately 5° C., it is in this way possible to dehumidify feed air. In the process, the first heat exchanger 11 cools the medium to the low outside temperature. The medium is expanded in the fourth valve 14 to temperatures between the outside air temperature and freezing point, in order to dehumidify the feed air. The dried feed air can then be heated to a desired temperature using a heating component. It is advantageous to use excess waste heat from the fuel cell system for this heating. It is also possible to use waste heat from other heat sources of the vehicle.

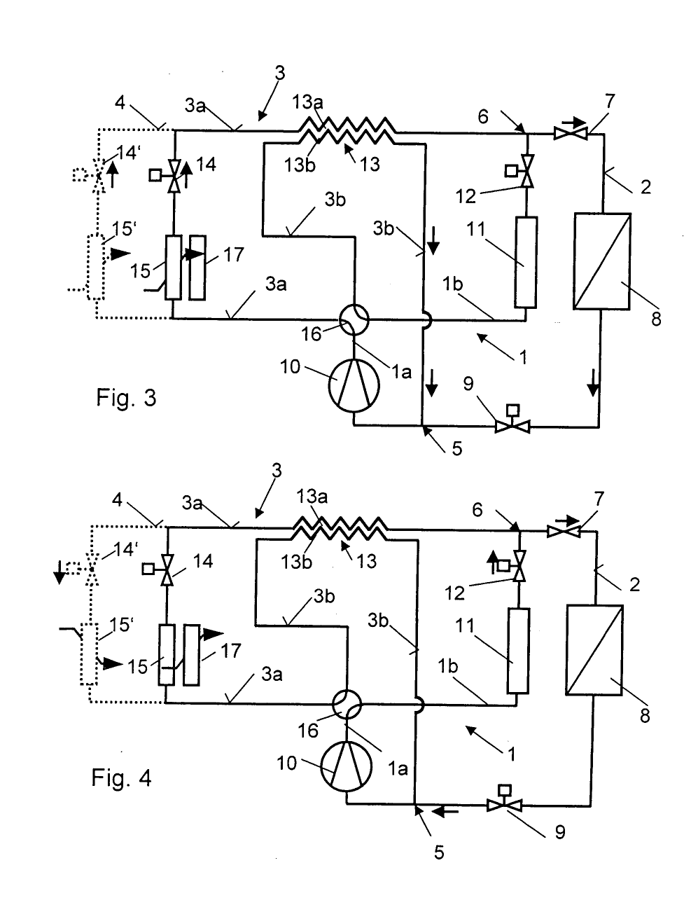

If the ambient temperature is below freezing, the fourth valve 14 is expediently closed in order to prevent the third heat exchanger 15 from icing up. If there is an excess of heat, for example in the fuel cell system, the feed air for the interior compartment can be heated without problems, for example using a heat exchanger, as illustrated in FIG. 3.

FIG. 3 shows a further preferred arrangement. Identical components are denoted by the same reference numerals as in FIG. 1 and 2. The third heat exchanger 15 is assigned a heater heat exchanger 17. Both heat exchangers 15, 17 can be used to heat the vehicle interior compartment. The heater heat exchanger 17 may expediently be incorporated into any further cooling circuit of the fuel cell system, so that waste heat from the fuel cell system is supplied to the heater heat exchanger 17, provided that the fuel cell system has an excess of heat.

The arrangement is particularly suitable for winter operation when there is a deficit of heat in the vehicle or, for example, during a cold-start phase of the fuel cell system.

The flow-diverter valve 16 is moved into a second switching position, in which the first section la of the first branch 1 is connected to the first section 3a of the second sub-circuit 3, and a second section 1b of the first branch 1 is connected to a second section 3b of the second sub-circuit 3. This leads to a regional flow reversal of the medium in the second sub-circuit 3. Therefore, in the region 3b, the medium still flows in the same direction as in FIGS. 1 and 2 between the combining point 5 and the flow-diverter valve 16, but in section 3a, between the branch point 6 and the flow-diverter valve 16 the direction of flow is now reversed.

The flow-diverter valve 16 is switched in such a way that the hot, compressed medium passes directly to the third heat exchanger 15, which is assigned to the interior compartment of the vehicle, where the medium is cooled while heating the cold feed air for the interior compartment. It is also possible for further heat sinks to be connected in parallel with the third heat exchanger 15 for heating.

For example, it is particularly expedient for a high-temperature coolant circuit of the fuel cell system to be used as heat sink, so that this circuit can be very quickly heated to its operating temperature. This advantageously makes it possible to shorten a cold-start phase of the fuel cell system.

In the second heat exchanger 13, the medium is cooled further as it passes through the region 13a and ultimately branches into the first sub-circuit 2 and the first branch 1 at the branch point 6. In branch 1, the medium is expanded in the third valve 12 to a temperature level below ambient temperature and takes up energy from the environment in the first heat exchanger 11.

The medium passes back to the compressor 10 via the flow-diverter valve 16 and the second heat exchanger 13.

Like in summer operation, in accordance with the figures described above, the medium is expanded to an intermediate pressure level across the first valve 7 in the first sub-circuit 2 and takes up heat in the component 8 before being further expanded across the second valve 9 to the same pressure level at the combining point 5 in the second sub-circuit 3 and then passes back to the compressor 10. If dehumidification of the interior compartment is desired, the flow-diverter valve 16 can briefly be moved into the first switching position shown in FIG. 2. The second switching position can subsequently be restored.

FIG. 4 illustrates a preferred configuration which is especially suitable for deicing the first heat exchanger 11 at low outside air temperatures. Identical components are denoted by the same reference numerals as in FIGS. 1-3.

At ambient temperatures below freezing, the air flowing through the first heat exchanger 11 may be cooled until it drops below the dew point. There is then a risk of the first heat exchanger 11 gradually icing up so that it can no longer take up any heat from the environment. Switching over the flow-diverter valve into the first switching position as shown in the figure, causes the first heat exchanger to be thawed by the hot medium compressed by the compressor 10. The medium takes up heat both from the component 8 after its expansion at the first valve 12 and in the compressor 10. It is optionally possible for waste heat from other sources, for example from the power electronics of the vehicle, to be incorporated in the medium circuit in another sub-circuit 4.

As soon as the temperature of the medium on leaving the first heat exchanger 11 exceeds a predetermined temperature threshold, preferably approximately 5° C., the thawing process is concluded and the flow-diverter valve 16 can be switched back into its second switching position as shown in FIG. 3. Preferable the first heat exchanger 11 is provided with a temperature sensor which monitors whether the temperature exceeds the upper temperature threshold or drops below a lower temperature threshold, and selects the switching position of the flow-diverter valve 16 as a function of the temperature of the air flowing through the first heat exchanger 11.

During the short thawing phase, the fourth valve 14 is expediently closed, so that no thermal energy is extracted from the medium via the third heat exchanger 15. This advantageously shortens the thawing phase.

The feed air for the vehicle is heated for this period of time by means of the heater heat exchanger 17, which may be incorporated, for example, in a high-temperature coolant circuit of the fuel cell system.

It is particularly expedient that the first heat exchanger 11 can be arranged in the region of the vehicle tail. If a standard air-cooled, high-temperature coolant circuit for the fuel cell system is provided, the heat exchanger thereof is customarily located in the vehicle radiator region and is exposed to the air stream. If the heat exchanger 11 of the air-conditioning system is arranged ahead of this radiator in air-hydraulic terms, both the dissipation of the heat of the air-conditioning system and the flow resistance caused by the heat exchanger 11 have an adverse effect on the dissipation of heat from the heat exchanger of the high-temperature coolant circuit. This problem is eliminated if the heat exchanger 11 is moved to the tail of the vehicle.

According to the invention, a medium in parallel sub-circuits 2, 3, 4 can be used to cool and/or heat components of a fuel cell system and of a cooling device and/or heating device for a vehicle interior compartment. The passage through the second valve 9 and/or the first valve 7 may be set as a function of a desired heating or cooling capacity in the first sub-circuit 2, so that a temperature level for cooling a heat-exchanging component 15, 15′ in the second and/or further sub-circuit 3, 4 can be provided by means of a valve position of a valve 14, 14′ connected upstream of the heat-exchanging component.

Under operating conditions which are unfavorable for a fuel cell vehicle, for example during overtaking maneuvers, prolonged uphill driving and the like, it may be necessary to briefly maximize the discharge of process water in the exhaust-air condenser of the fuel cell component 8. With thermally comfortable interior compartment conditions, the power of the air-conditioning system can be reduced or it can be switched off briefly for the vehicle interior in order to obtain the maximum cooling capacity at the condenser of the fuel cell component 8. The air-conditioning comfort in the passenger compartment can be maintained for a certain period of time by using measures such as switching to the re-circulated air mode in the interior compartment.

Recovery of process water in the exhaust-air condenser component 8 on demand in continuous part-load operation of the refrigeration installation is in energy terms considerably more economical than cyclical on/off refrigeration operation.

In the event of a brief demand for maximum driving power, for example during an overtaking maneuver, the refrigeration installation together with its auxiliary equipment can be switched off. The electric power which is freed up in this way is then fully available to the electric driving motor or other components. This strategy is expedient if there is a sufficient stock of process water available for the fuel cell system during the interruption of refrigeration operation.

1. A vehicle having an air-conditioning system and a heat source (8), comprising:
a common medium circuit including a medium for cooling and heating the air-conditioning system and the heat source (8),
means (10, 7, 8, 9, 12, 14, 14′) for expanding and compressing the medium in the medium circuit, said medium circuit including
a first branch (1) extending between a combining point (5) and a branching point (6), where said medium circuit branches off into a first sub-circuit (2) extending through the heat source (8), and a second sub-circuit (3) forming the air-conditioning system, said sub-circuits being combined again at the combining point (5), and
a compressor (10) and a first heat exchanger (11) in heat exchange with ambient air, being arranged in the first branch (1) between the combining point (5) and the branching point (6).

2. The vehicle as claimed in claim 1, wherein a first valve (7) for expanding the medium to a predetermined first pressure (p1) is arranged in the first sub-circuit (2) upstream of the heat source (8) in the direction of flow of the medium, and a second valve (9) for expanding the medium to a second pressure (p2) is arranged in the first sub-circuit (2) downstream of the heat source (8) in the direction of flow of the medium.

3. The vehicle as claimed in claim 1, wherein a third valve (12) is provided in the first branch (1).

4. The vehicle as claimed in claim 1, wherein a second heat exchanger (13), a fourth valve (14) and a third heat exchanger (15) are provided in sequence in the direction of flow of the medium in the second sub-circuit (3), the medium being routed through a first region (13a) of the second heat exchanger (13).

5. The vehicle as claimed in claim 4, wherein the medium, between the fourth valve (14) and the combining point (5), is routed through a second region (13b) of the second heat exchanger (13).

6. The vehicle as claimed in claim 4, wherein the third heat exchanger (15) is joined by an additional heater heat exchanger (17), to which waste heat from the heat source (8) is supplied.

7. The vehicle as claimed in claim 1, wherein a flow-diverter valve (16) is arranged downstream of the compressor (10) and has a second switching position in which a first section (1a) of the first branch (1) is connected to a first section (3a) of the second sub-circuit (3) and a second section (1b) of the first branch (1) is connected to a second section (3b) of the second sub-circuit (3).

8. The vehicle as claimed in claim 1, wherein at least one further sub-circuit (4) for controlling the temperature of further components (15′) of the vehicle is provided in parallel with the second sub-circuit (3).

9. The vehicle as claimed in claim 1, wherein the medium in the medium circuit is gaseous under standard conditions.

10. The vehicle as claimed in claim 1, wherein the medium includes carbon dioxide.

11. The vehicle as claimed in claim 1, wherein the first heat exchanger (11) is arranged in the region of the vehicle tail.

12. The vehicle as claimed in claim 1, wherein the heat source (8) is part of a fuel cell system.

13. The vehicle as claimed in claim 12, wherein a condenser for cooling cathode exhaust air of the fuel cell system is arranged as heat source (8) in a cathode exhaust-gas line of a fuel cell unit, with the medium of the first sub-circuit (2) flowing through the condenser for cooling purposes.

14. The vehicle as claimed in claim 12, wherein said heat source is a heat-exchanging component of a gas generation system of the fuel cell system for generating operating fuel for the fuel cell unit and the medium of the first sub-circuit (2) flows through said heat exchanging component.

15. The vehicle as claimed in claim 12, wherein the medium of the first sub-circuit (2) also flows through regions of the fuel cell unit.

16. A method for controlling the temperature of a vehicle as claimed in claim 1, wherein a common medium in parallel sub-circuits (2, 3, 4) is used to cool and heat a heat source (8) and a cooling and a heating device of a vehicle interior compartment.

17. The method as claimed in claim 16, wherein the passage of the medium through the first valve (7) and the second valve (9) is controlled as a function of a desired heating or cooling capacity in the first sub-circuit (2).

18. The method as claimed in claim 16, wherein a temperature level for cooling a heat-exchanging component (15, 15′) in the second and further sub-circuit (3, 4) is controlled by a valve position of a valve (14, 14′) arranged upstream of the heat-exchanging component.

19. The method as claimed in claim 18, wherein the temperature level is set as a function of demand at individual heat-exchanging components (15, 15′) by changing the valve positions of the valves (14, 14′) arranged upstream of the second valve (9).

20. The method as claimed in claim 16, wherein, in order to heat the vehicle interior compartment at low outside temperatures, the switching valve (16) is operated in a first switching position, in which the compressed medium is fed to the third heat exchanger (15) for heating the latter.

21. The method as claimed in claim 20, wherein, at low outside temperatures, the switching valve (16) is moved periodically into a second switching position, in which the compressed medium heats the first heat exchanger (11) for de-icing the first heat exchanger (11).

22. The method as claimed in claim 21, wherein, the switching valve (16) is switched from its second switching position into its first switching position when a predetermined temperature threshold assigned to the first heat exchanger (11) is exceeded.

23. The method as claimed in claim 21, wherein, as long as the switching valve (16) is in its second switching position, the vehicle interior compartment is heated via a heater heat exchanger (17) which is incorporated into a separate coolant circuit.

24. The method as claimed in claim 16, wherein, in order to dehumidify feed air for the vehicle interior compartment when the fuel cell system has warmed up to its operating temperature, the switching valve (16) is moved into its second valve position when the ambient temperature is above freezing, and the medium is expanded via the fourth valve (14) to a temperature between the freezing point and ambient temperature, such that the feed air is dehumidified by the third heat exchanger (15) and is then heated by a further heater heat exchanger (17).

25. The method as claimed in claim 16, wherein the medium is conducted through a condenser in a cathode exhaust-gas line of a fuel cell system (8) for cooling the cathode exhaust gas.

26. The method as claimed in claim 25, wherein, in the event of increased separation of water out of the fuel cell system exhaust gas being required, only the first sub-circuit (2) is operated.

27. The method as claimed in claim 17, wherein if a high driving power is required, the medium circuit including electrical consumers (10, 7, 9, 14, 14′) are briefly switched off.
